(19) United States
(12) Patent Application Publication
(10) Pub. No.: US 2012/0162732 A1
(43) Pub. Date: Jun. 28, 2012

(54) DEVICE AND METHOD FOR A HOLOGRAPHIC DISPLAY WITH ELECTROMECHANICAL ACTUATED MIRROR DISPLAY

(75) Inventors: John H. Hong, San Clemente, CA (US); Ion Bita, San Jose, CA (US); Chong U. Lee, San Diego, CA (US); Yuriy Reznik, San Diego, CA (US)

(73) Assignee: QUALCOMM MEMS Technologies, Inc., San Diego, CA (US)

(21) Appl. No.: 12/976,669

(22) Filed: Dec. 22, 2010

(51) Int. Cl. G03H 1/08; G03H 1/24; G03H 1/22

(52) U.S. Cl. 359/9; 359/32

(57) ABSTRACT

The present disclosure provides systems, methods and apparatus for producing holographic displays using an electromechanical systems device. In one aspect, the method can be implemented to allow for simultaneous modulation of phase and amplitude of light in a display device composed of a plurality of pixels. A light source can provide sufficiently coherent light to a light guide, which can direct the light to a plurality of reflective members. The reflective members can reflect the light to a pinhole-lenslet array. The combination of the pinhole-lenslet array and the reflective members can act as a spatial light modulator, modulating the phase and amplitude of the light reflected by the reflective members. The lenslet can focus the light to a plane at the opening of the pinhole, wherein the light can exit the pinhole to be viewed in combination with light from additional pixels, and can be viewed as a holographic image.

### TECHNICAL FIELD

This disclosure is related to producing holographic displays using an electromechanical systems device.

### DESCRIPTION OF THE RELATED TECHNOLOGY

In holography, generally, the wave nature (amplitude and phase distribution) of light scattered by an object can be recorded on film or other media by mixing the object waves with a locally generated reference beam that is mutually coherent with the scattered object waves. The object waves can then be reconstructed by illuminating the recorded hologram with the reference wave, since the light that is scattered by the recorded hologram carries with it the originally recorded amplitude and phase distribution. Alternatively, digital holography can work with artificially created object waves and can display the holographic information on a suitable spatial light modulator (SLM) that is capable of modifying both amplitude and phase of a coherent wave.

Electromechanical systems include devices having electrical and mechanical elements, actuators, transducers, sensors, optical components (e.g., mirrors), and electronics. Electromechanical systems can be manufactured at a variety of scales including, but not limited to, microscales and nanoscales. For example, microelectromechanical systems (MEMS) devices can include structures having sizes ranging from about a micron to hundreds of microns or more. Nanoelectromechanical systems (NEMS) devices can include structures having sizes smaller than a micron including, for example, sizes smaller than several hundred nanometers. Electromechanical elements may be created using deposition, etching, lithography, and/or other micromachining processes that etch away parts of substrates and/or deposited material layers or that add layers to form electrical and electromechanical devices. Interferometric modulator devices have a wide range of applications, and are anticipated to be used in improving existing products and creating new products, especially those with display capabilities.

### SUMMARY

The systems, methods and devices of the present disclosure each have several innovative aspects, no single one of which is solely responsible for the desirable attributes disclosed herein.

One innovative aspect of the subject matter described in this disclosure can be implemented in a holographic display device, including a plurality of reflective members being configured to selectively adjust. The display device further includes a pinhole-lenslet array, including a plurality of pinholes and a plurality of lenslets, wherein at least one of the phase and amplitude of light is selectively modulated, based, at least in part on, the positioning of the plurality of reflective members. The display device can include a light source configured to supply light to the display device and a light guide configured to receive light from the light source and direct light to at least one of the plurality of reflective members. The light guide can be disposed between the reflective members and the pinhole-lenslet array. The light guide can be disposed between the plurality of lenses and the plurality of pinholes of the pinhole-lenslet array. The plurality of reflective members can be configured to selectively tilt and displace. The display device can include a Fabry-Pérot element disposed between the reflective members and the pinhole-lenslet array.

In some implementations, the display device can include a plurality of electrode segments located proximately behind the plurality of reflective members, the plurality of electrode segments being configured to selectively displace or tilt at least one of the reflective members. The plurality of electrode segments can selectively displace or tilt the reflective members based upon an image data input signal.

Another innovative aspect can be implemented in a method for displaying a holographic image, including receiving a plurality of phase and amplitude input signals, tilting and displacing a plurality of reflective members according to the input signals, directing light towards the plurality of reflective members, and reflecting the light via the plurality of reflective members towards a pinhole-lenslet array, including a plurality of pinholes and a plurality of lenslets. The light can be focused by the lenslets towards the pinholes. In some implementations, the phase of light can be modulated by axially displacing at least one of the plurality of reflective members and the amplitude of light can be modulated by tilting at least one of the plurality of reflective members and reflecting light through the pinhole-lenslet array. The method can further include receiving light in a light guide from a light source, wherein at least a portion of the received light is directed towards one or more of the plurality of reflective members. In some implementations, the light guide can be disposed between the reflective members and the pinhole-lenslet array. In some implementations, the light guide can be disposed between the plurality of lenses and the plurality of pinholes of the pinhole-lenslet array.

In some implementations, the light source can generate a pulsed light, including red, green and blue light, wherein each color of light can be pulsed sequentially in time. The light source can generate a constant light, including red, green and blue light, wherein each color of light can be directed by the light guide to a corresponding reflective member of the plurality of reflective members. In some implementations, the light source can generate a time-modulated light, including red, green, and blue light.

In some implementations, the method can further include passing white light through a plurality of Fabry-Pérot elements disposed between the reflective members and the pinhole-lenslet array, wherein the light of only one color is directed towards the reflective members.

Another innovative aspect can be implemented as a holographic display device including means for reflecting light, the light reflecting means being configured to selectively adjust, means for focusing light, and means for selectively blocking light, wherein the light focusing means and light blocking means modulate at least one of the phase and amplitude of the light reflected to at least one of the light focusing means or the light blocking means based at least in part on the positioning of the light reflecting means. The display device can also include means for emitting light. In some implementations, the display device can further include means for guiding light, the light guiding means being configured to receive light from the light emitting means and direct light to the light reflecting means. In some implementations, the light guiding means can be disposed between the light reflecting means and the light focusing means. In some implementations, the light guiding means can be disposed between the light reflecting means and the light blocking means. In some implementations, the light blocking means can be a pinhole. In some implementations, the light emitting means can be one or more lasers.

Details of one or more implementations of the subject matter described in this specification are set forth in the accompanying drawings and the description below. Other features, aspects, and advantages will become apparent from the description, the drawings, and the claims. Note that the relative dimensions of the following figures may not be drawn to scale.

### BRIEF DESCRIPTION OF THE DRAWINGS

FIG. 1 is an example schematic illustrating an implementation of a holographic display device.

FIG. 2 is an example schematic illustrating an implementation of a single pixel of a holographic display device.

FIG. 3 is an example schematic illustrating an implementation of a single pixel of a holographic display device.

FIG. 4 is an example schematic illustrating phase modulation of light in a holographic display device.

FIG. 5 is an example schematic illustrating amplitude modulation of light in a holographic display device.

FIG. 6 is an example schematic illustrating simultaneous phase and amplitude modulation of light in a holographic display device.

FIGS. 7A-C illustrate example schematics of the electrode segments of a holographic display device.

FIGS. 8A and 8B are example schematics illustrating an implementation of light guides.

FIG. 9 is an example system flow diagram illustrating a method of displaying a holographic display.

FIG. 10 is an example schematic illustrating one implementation of a single pixel of a holographic display utilizing a Fabry-Pérot element.

FIGS. 11A and 11B are example system block diagrams illustrating an implementation of a holographic display device including a plurality of interferometric modulators.

### DETAILED DESCRIPTION

The following detailed description is directed to certain implementations for the purposes of describing the innovative aspects. However, the teachings herein can be applied in a multitude of different ways. The described implementations may be implemented in any device that is configured to display an image, whether in motion (e.g., video) or stationary (e.g., still image), and whether textual, graphical or pictorial. More particularly, it is contemplated that the implementations may be implemented in or associated with a variety of electronic devices such as, but not limited to, mobile telephones, multimedia Internet enabled cellular telephones, mobile television receivers, wireless devices, smartphones, bluetooth devices, personal data assistants (PDAs), wireless electronic mail receivers, hand-held or portable computers, netbooks, notebooks, smartbooks, printers, copiers, scanners, facsimile devices, GPS receivers/navigators, cameras, MP3 players, camcorders, game consoles, wrist watches, clocks, calculators, television monitors, flat panel displays, electronic reading devices (e.g., e-readers), computer monitors, auto displays (e.g., odometer display, etc.), cockpit controls and/or displays, camera view displays (e.g., display of a rear view camera in a vehicle), electronic photographs, electronic billboards or signs, projectors, architectural structures, microwaves, refrigerators, stereo systems, cassette recorders or players, DVD players, CD players, VCRs, radios, portable memory chips, washers, dryers, washer/dryers, parking meters, packaging (e.g., MEMS and non-MEMS), aesthetic structures (e.g., display of images on a piece of jewelry) and a variety of electromechanical systems devices. The teachings herein also can be used in non-display applications such as, but not limited to, electronic switching devices, radio frequency filters, sensors, accelerometers, gyroscopes, motion-sensing devices, magnetometers, inertial components for consumer electronics, parts of consumer electronics products, varactors, liquid crystal devices, electrophoretic devices, drive schemes, manufacturing processes and electronic test equipment. Thus, the teachings are not intended to be limited to the implementations depicted solely in the Figures, but instead have wide applicability as will be readily apparent to one having ordinary skill in the art.

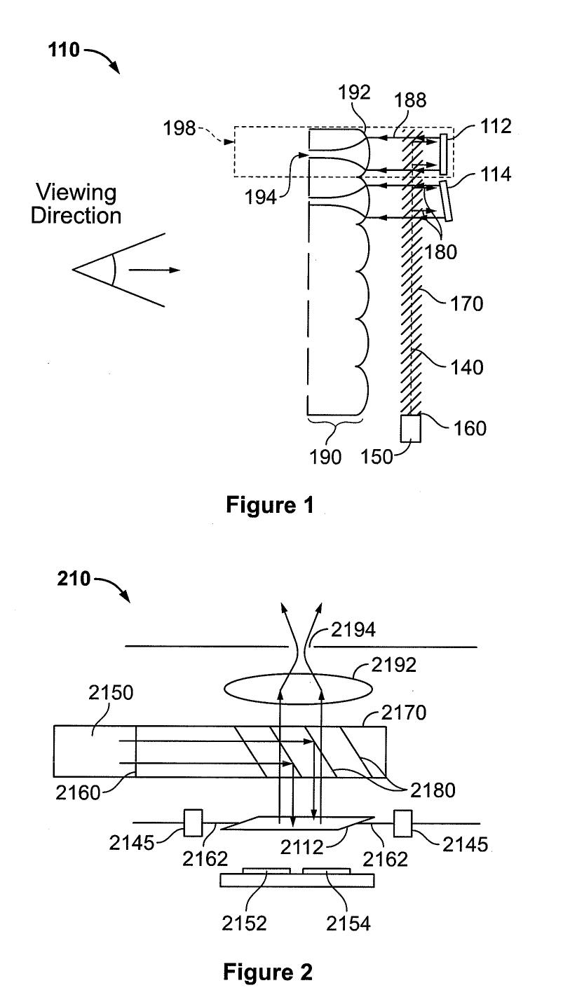

FIG. 1 is an example schematic illustrating an implementation of a holographic display device. As further described below, the holographic display device 110 also may include components for actuation of the reflective members. The holographic display device 110 may include an array of pixels arranged in rows and columns, for example, arranged along an x-y plane, to make up the holographic display device 110. The array of pixels making up the holographic display device 110 can be implemented from interferometric modulator (IMOD) devices. Individual pixels of a holographic display device 110 can be configured to modulate the amplitude and phase of light emanating from the pixel. The light emanating collectively from the array of pixels can travel from the holographic display device 110 to the viewer as a wave front. As the wave front reaches the viewer of the holographic display device 110, with the light from each pixel being individually modulated in terms of its phase and amplitude, the wave front appears to the viewer of the holographic display device 110 as a holographic image. Thus, the wave front includes light from a plurality of pixels, wherein the light from each pixel is capable of being modulated in terms of phase and amplitude.

The holographic display device 110 can utilize reflective members, such as reflective members 112, 114, in combination with a pinhole-lenslet array 190 to modulate the phase and amplitude of light emanating from the holographic display device 110. In order to modulate the light emanating from the holographic display device 110, in this implementation, first the light 140 emitted from the light source 150 enters the edge 160 of the light guide 170 and propagates through the light guide 170 utilizing total internal reflection (TIR). TIR causes the light to reflect internally within the light guide 170 until it reaches the turning features 180, which can be included in the light guide 170 to redirect at least a portion of the light propagating through the light guide 170 towards the reflective members 112, 114. The light guide 170 can be designed to propagate a spatially uniform beam of light to each of the reflective members 112, 114 in the holographic display device 110.

The reflective members 112, 114 can be electromechanical devices configured to axially displace (for example, move front-to-back or back-to-front) and tilt in order to modulate the phase and amplitude of the incoming light. The reflective members 112, 114 can reflect the light received from the light guide 170 back through the light guide 170 towards the pinhole-lenslet array 190.

The lenslet 192 of pixel 198 can be configured such that when the reflected light 188 is focused by the lenslet 192 towards the pinhole 194, the pinhole 194 can be configured to pass the diffraction-limited beam of light to the viewer with little attenuation. In some implementations, the lenslet 192 can be a positive lens, preferably biconvex or plano-convex, such that a beam of light passing through the lenslet 192 is converged, or focused, by the lenslet 192 to a focal point at the plane of the pinhole 194.

The reflective members 112, 114 are merely representative of the plurality of reflective members that could be associated with an array of pixels in making up a holographic display device 110. The number of pixels (e.g., IMODs), and hence the number of reflective members, actually used in creating a holographic display can be dependent on the size of the holographic display device 110 and the required display resolution.

In some implementations, a single pixel 198 can be configured to modulate light phase and amplitude as part of a collection of pixels in order to create a holographic display. FIG. 2 is an example schematic illustrating an implementation of a single pixel of a holographic display device. FIG. 2 illustrates, for example, an implementation of a pixel 210 that may be configured to modulate the light emanating from, e.g., the holographic display device 110 (e.g., pixel 198). The individual pixel 210 can be illuminated by a light source 2150. The light source 2150 may be coupled to the edge 2160 of a light guide 2170, wherein a portion of light emitted by the light source 2150 enters the edge 2160 of the light guide 2170 and propagates through the light guide 2170 via TIR. The light guide 2170 may include, for example, one or more film, film stack, sheet, or slab-like components which allows for propagation of the light by way of TIR. In the illustrated implementation, the light guide 2170 is positioned between a reflective member 2212 and a lenslet 2192. The light guide 2170 may include light turning features 2180 that direct the light propagating in the light guide 2170 towards the reflective member 2112.

After light enters the light guide 2170 from the light source 2150, the light can be propagated through the light guide 2170 until it reaches a turning feature 2180; the turning feature 2180 can change the light direction from traveling parallel in the plane of the holographic display device 110 to traveling normal to the plane of the holographic display device 110. Thus, the light can travel from the light guide 2170 to the reflective member 2112 associated with the pixel 210.

In some implementations, the reflective member 2112 may be tilted or axially displaced in order to modulate the phase and amplitude of the light received. Two sides of the reflective member 2112 are attached to stationary anchors 2145 by torsional hinges 2162, the hinges 2162 being configured to allow the reflective member 2112 to tilt and/or axially shift when a potential difference is created between the reflective member 2112 and one or more electrode segments 2152, 2154. In FIG. 2, because the reflective member 2112 is in a quiescent state (i.e., being neither displaced nor tilted) the light emanating from the pixel 210 is not modulated.

The reflective member 2112 can reflect the light received from the light guide 2170 back through the light guide 2170 to the lenslet 2192. The lenslet 2192 focuses the light to a point of convergence at the plane of the pinhole 2194. The light exits the pinhole 2194 and can be perceived by, e.g., a viewer as part of a holographic display.

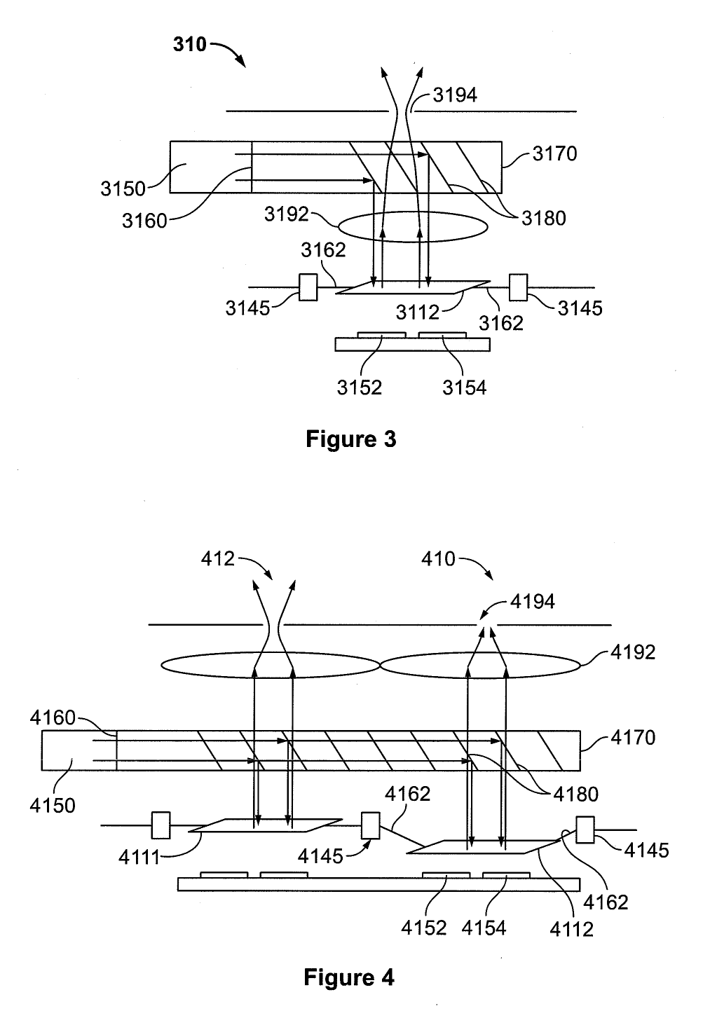

FIG. 3 is an example schematic illustrating an implementation of a single pixel of a holographic display device. FIG. 3 illustrates, for example, an implementation of a pixel 310 that that may be configured to modulate the light emanating from, e.g., the holographic display device 110. The implementation of the pixel 310 shown in FIG. 3 is different from the pixel 210 in FIG. 2 in that the lenslet 3192 in FIG. 3 can be located between the reflective member 3112 and the light guide 3170. An individual pixel 310 is illuminated by a light source 3150. The light source 3150 may be coupled to the edge 3160 of a light guide 3170, wherein a portion of light emitted by the light source 3150 enters the edge 3160 of the light guide 3170 and propagates through the light guide 3170 via TIR. The light guide 3170 may include, for example, one or more film, film stack, sheet, or slab-like component which allows for propagation of the light by way of TIR. In the illustrated implementation, the light guide 3170 is positioned between the lenslet 3192 and the pinhole 3194. The light guide 3170 may include a plurality of turning features 3180 that direct the light propagating in the light guide 3170 towards the reflective member 3112.

After light enters the light guide 3170, the light can be propagated through the light guide 3170 until it reaches a turning feature 3180; the turning feature 3180 can change the light direction from traveling parallel in the plane of the holographic display device 110 to traveling normal to the plane of the holographic display device 110. Thus, the light can travel from the light guide 3170, through the lenslet 3192, to the reflective member 3112 associated with the pixel 310.

In some implementations, the reflective member 3112 may be tilted and/or axially displaced in order to modulate the amplitude and/or phase of the light which it is reflecting. Two sides of the reflective member 3112 are attached to, e.g., immovable, anchors 3145 by torsional hinges 3162, the hinges 3162 allowing the reflective member 3112 to tilt and/or axially shift when a potential difference is created between reflective member 3112 and one or more electrode segments 3152, 3154. In FIG. 3, because the reflective member 3112 is in the quiescent state (i.e., being neither tilted nor displaced) the light emanating from the pixel 310 is not modulated.

The reflective member 3112 can reflect the light received from the light guide 3170 through the lenslet 3192. The lenslet 3192 can be configured to focus the light to a point of convergence at the plane of the pinhole 3194. In some implementations, the lenslet 3192 should be designed to take into consideration any reflective or refractive aberrations associated with the light guide 3170 so as to improve the quantity and quality of light passing through the light guide 3170 before reaching the pinhole 3194. The light exits the pinhole 3194 and can be perceived by, e.g., a viewer as part of a holographic display.

In classical holography, a stable fringe pattern can be recorded on a medium due to the interference between two coherent light beams, i.e., the object beam and the reference beam. The medium can record the relative phase and amplitude differences between the object and reference beams. A three-dimensional hologram can be reconstructed by passing the reference beam back through the medium in order to project the recorded fringe patterns. In the alternative, a computer-generated hologram (CGH) can be created from the knowledge of a wave front or the digital rendition of the object to be represented. The wave front characteristics for a given pixel, including phase and amplitude, can be transmitted to the holographic display in the form of an image digital input signal. An image digital input signal is the digital representation of an analog wave front. Thus, a CGH does not require two separate coherent light beams, but instead requires only a single light source with the light being correctly modulated according to the image data input signal in order to display the holographic wave front.

A single pixel in a holographic display device can be configured to modulate the phase of light for that pixel in order to create a holographic display as part of a collection of pixels. The light phase can be modulated by displacing the reflective member front-to-back or back-to-front. FIG. 4 is an example schematic illustrating phase modulation of light in a holographic display device. FIG. 4 illustrates an example implementation of a pixel 410 that is configured to modulate the phase of light emanating from a reflective member 4112 in, e.g., the holographic display device 110. An image data input signal can carry a signal to the pixel 410 indicating the need for phase modulation in the pixel 410. Phase modulation of the light in the pixel 410 can be initiated by receipt of the image data input signal at electrode segments 4152 and 4154.

The reflective member 4112 may be conductive and responsive to an electrical potential. The reflective member 4112 can be attached to fixed anchors 4145 using torsional hinges 4162, which allow the reflective member 4112 to tilt or displace as dictated by the image data input signal. Creation of an electrical potential can cause the reflective member to move or adjust within the confines allowed by the torsional hinges 4162 to which the reflective member 4112 is attached. To perform the phase modulation the reflective member 4112 can be vertically displaced by the equal activation of the two electrodes segments 4152 and 4154 according to the image data input signal received. When voltage is applied to both electrode segments 4152 and 4154 equally, an electrical potential is created between the reflective member 4112 and the electrode segments 4152 and 4154. The electrical potential can create a uniform electrostatic force causing the reflective member 4112 to be axially and uniformly displaced vertically towards the electrode segments 4152, 4154.

The light source 4150 provides light through the edge of the light guide 4160 to the light guide 4170, which can then, with the benefit of the turning features 4180, direct the light towards the reflective member 4112. The reflective member 4112 can reflect the light received from the light guide 4170 back through the light guide 4170, through the lenslet 4192, and out the pinhole 4194. The light reflected from this axially displaced reflective member 4112 can vary in phase by up to Δφ=(4πL/λ)=2π radians (where λ is the wavelength and L is the reflective member's axial displacement relative to the quiescent position) as compared to a pixel 412, which has its reflective member 4111 in the quiescent state. The image data input signal supplied to the pixel 410 can change as the holographic image being displayed by the holographic display device changes. The image data input signal may change, either requiring more or less (e.g., zero) phase modulation for the pixel 410. As a consequence, the voltage supplied to the electrode segments 4152 and 4154 can be modified to adjust the reflective member 4112 according to the new light phase required for the display. For example, an image data input signal requiring increased phase modulation will cause the electrode segments to supply a greater electrical potential between the reflective member 4112 and the electrode segments 4152 and 4154. In the event phase modulation is no longer required for the pixel 410, the image data input signal can indicate to the electrode segments 4152 and 4154 to return to a deactivated state, which can then release the electrostatic force on the reflective member 4112, thus returning the reflective member 4112 to the quiescent state.

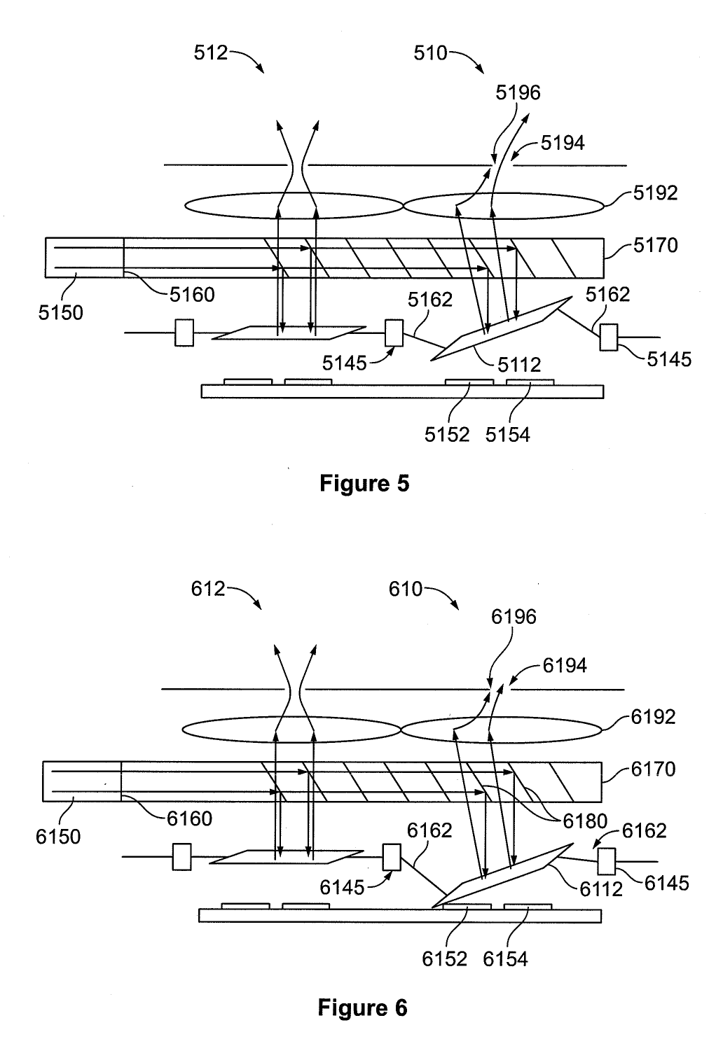

FIG. 5 is an example schematic illustrating amplitude modulation of light in a holographic display device. A single pixel 510 can be configured to modulate the Amplitude of light as part of a collection of pixels in order to create a holographic display. The amplitude of light can be modulated by tilting the reflective member 5112 so the reflected light reaches the lenslet 5192 at some angle incident to the plane of the holographic display device 110. The lenslet 5192 can focus the light towards pinhole 5194 in such a manner that a portion of the light can be blocked by the edge 5196 of the pinhole 5194, thereby modulating the amplitude. The light source 5150 can be coupled to the edge 5160 of the light guide 5170 to provide light to the light guide 5170. The light guide 5170 can direct the light towards the reflective member 5112. The reflective member 5112 can be attached to fixed anchors 5145 by way of torsional hinges 5162, which allow the reflective member 5112 to tilt or displace as dictated by the image data input signal. In some implementations, when an image data input signal is received, the reflective member 5112 can be tilted by the activation of only one electrode 5152. When voltage is applied to the electrode 5152 corresponding to one side of the reflective member 5112 and less (or zero) voltage is applied to the electrode 5154 on the other side of the reflective member 5112, the reflective member 5112 will tilt in the direction of the electrode 5152 where the greater voltage is applied.

The reflective member 5112 can reflect the light received from the light guide 5170 at an angle incident to the plane of the holographic display device 110 through the light guide 5170 towards the lenslet 5192. Because the light is traveling at an angle when it reaches the lenslet 5192, the lenslet 5192 can be configured to focus light to a position that is misaligned with the opening of the pinhole 5194. Thus, a portion of light reflected by the reflective member 5112 can pass through the pinhole 5194 and a portion of light can be blocked by the pinhole edge 5196. Blocking a portion of the light at the pinhole edge 5196 modulates the amplitude of the portion of light that does pass through the pinhole 5194. Thus, the total light output is modulated (in this case, reduced) in amplitude by blocking a portion of the exiting light.

In some implementations, the holographic display device 110 will display dark or black images. Thus, when the image data input signal requires a black pixel, an electrode 5152 can be activated to tilt the reflective member 5112 to an extreme angle such that none of the light passes through the pinhole 5194 because the entirety of the reflected light is blocked by the pinhole edge 5196.

As the image displayed by the holographic display device 110 changes, the image data input signal may change, for example, requiring less (e.g., zero) amplitude modulation, for the pixel 510. In this case, the electrode 5152 can be returned to the deactivated state, which then releases the electrostatic pull on the reflective member 5112, and thus, returns the reflective member 5112 and pixel 510 to the quiescent state.

In some implementations, a single pixel can provide light which is simultaneously modulated in terms of phase and amplitude. FIG. 6 is an example schematic illustrating simultaneous phase and amplitude modulation of light in a holographic display device. FIG. 6 illustrates an example implementation of a pixel 610 that is being configured to simultaneously modulate the phase and amplitude of light emanating from a reflective member 6112 in a single pixel 610. The light source 6150 can be coupled to the edge 6160 of the light guide 6170 to provide light to the light guide 6170, which in turn directs the light towards the reflective member 6112. In some implementations, when an image data input signal is received, the reflective member 6112 can be tilted and displaced by the activation of both electrode segments 6152 and 6154. The reflective member 6112 can be attached to fixed anchors 6145 using torsional hinges 6162, which allow the reflective member 6112 to tilt or displace as dictated by the image data input signal. When a greater voltage is applied to the electrode segment 6152 than the voltage applied to the electrode segment 6154, the reflective member 6112 will displace axially and also tilt in the direction of the electrode segment 6152 where the greater voltage is applied.

The light source 6150 provides light through the edge of the light guide 6160 to the light guide 6170, which can then, with the benefit of the turning features 6180, direct the light towards the reflective member 6112. The reflective member 6112 reflects the light received from the light guide 6170 back through the light guide 6170 towards the lenslet 6192 at an angle incident to the plane of the display device and with modulated phase. Because the light is traveling at an angle when it reaches the lenslet 6192, the lenslet 6170 focuses the light to a position that is misaligned with the opening of the pinhole 6194. Thus, a portion of light reflected by the reflective member 6112 passes through the pinhole 6194 and a portion of light is blocked by the pinhole edge 6196. Blocking a portion of the light at the pinhole edge 6196 modulates the amplitude of the portion of light that does pass through the pinhole 6194. Because the reflective member 6112 is axially displaced in addition to being tilted toward the more electrostatic electrode segment 6152, the light leaving the pinhole 6194 is also phase modulated.

In some implementations, the light source, e.g., light source 5150 of the holographic display device 110 can be, or formed from, a laser or series of lasers. In some other implementations, the light source can include one or more light emitting elements, for example, a light emitting diode (LED), a light bar, a cold cathode florescent lamp (CCFL), or other suitably spatial coherent sources of light.

In some implementations, to produce a full-color hologram, the light source will include red, green and blue (RGB) constant, or continuous wave (CW), light beams. A CW light beam can produce a continuous output beam of red, green and blue light directed towards the light guide. In this implementation, each RGB colored light source can be associated with a corresponding pixel or plurality of pixels. For example, the geometry of the light guide may be configured to direct the light emanating from the red light source to the reflective members associated with the red pixels, the light emanating from the green light source to the reflective members associated with the green pixels, and the light emanating from the blue light source to the reflective members associated with the blue pixels. In such an implementation, each RGB colored pixel can modulate, respectively, the phase and amplitude of the RGB colored light directed to the pixel. A specific colored pixel may be turned off (i.e., turned black) by modulating the amplitude such that the entirety of the colored light beam is blocked by, e.g., the edge of the pinhole. In some implementations, different colored pixels may be arranged in close proximity to one another, such that when pixels of different colors are illuminated next to or near each other, the light emanating from the different colored pixels combines or mixes upon exit from the pinholes to produce a different color or different shade of color visible to the viewer. Thus, in such an implementation, the combination of RGB pixels in the holographic display produces a full-color hologram.

In some other implementations, to produce a full-color hologram, the light source can include pulsed, or time-sequenced, light. The light source can emit RGB pulses of light in a rapid time-sequenced manner to each pixel. Each pixel in the display can be configured to receive and display red, green and blue light, but importantly, not at the same time; each pixel can receive and display only a single color (i.e., red, green or blue) at a time. For example, a given pixel may display red light for a given amount of time when red light is pulsed to that pixel; then the same pixel may also display green light when green light is pulsed to that pixel. When light of two or more different colors is pulsed in rapid succession to the reflective member associated with a given pixel, a viewer of the holographic display will see the pixel as a combination of those two or more colors. Different colors and shades of colors can be produced by varying the colors pulsed to a pixel and the duration of the pulse. For example, when red and green light are pulsed sequentially for equal duration to the reflective member associated with a given pixel, the viewer of the holographic display will see, e.g., yellow light emanate from that pixel. Thus, each pixel can modulate the phase and amplitude of the colored light directed to the pixel. In such an implementation, pulsing RGB light to the pixels in the holographic display produces a full-color hologram.

In some implementations, the light source will include only a single colored light source to produce a monochromatic hologram. In this implementation, the single colored light source can be directed to the reflective member associated with each pixel in the holographic display. The wavelength of light provided by the light source can dictate the color of monochromatic light seen by the viewer of the holographic display. A monochromatic hologram can include a continuous wave light source because, in this implementation, a single pixel will display light of a single color.

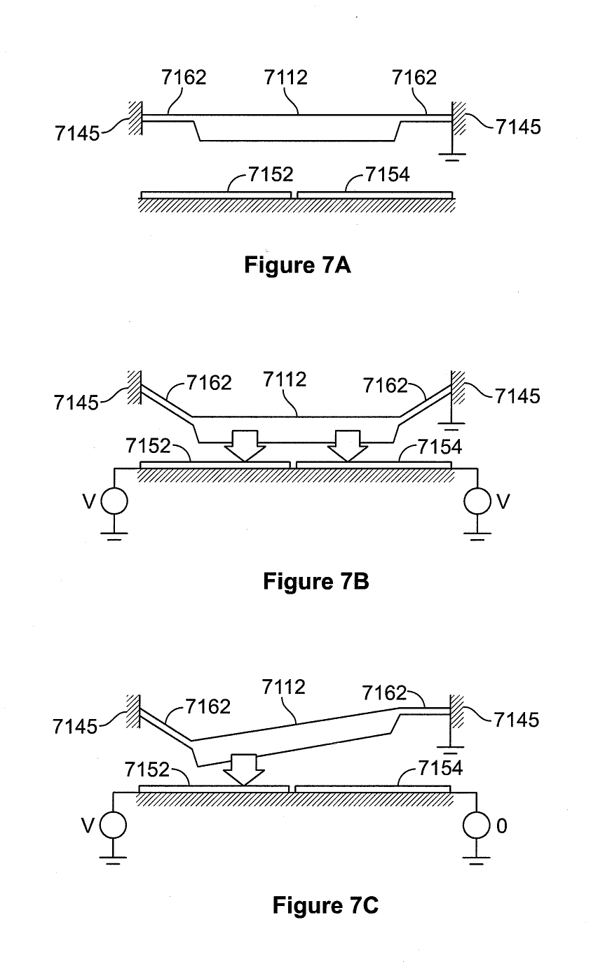

FIGS. 7A-7C illustrate example schematics of the electrode segments of a holographic display device. As described above, when a charge is applied to the electrode segments, electrostatic forces associated with the charge can cause the reflective members to be tilted and/or displaced from their relaxed position. FIG. 7A shows a reflective member 7112 attached by torsional hinges 7162 to fixed anchors 7145. Two or more electrode segments 7152, 7154 are positioned underneath the reflective member 7112 in close enough proximity to the reflective member 7112 such that when a voltage is supplied to one or more electrode segments 7152, 7154, a potential difference is created between the segments 7152, 7154 and the reflective member 7112. The electrostatic force originating from the electrode segments 7152, 7154 is sufficient to pull the reflective member 7112 towards the electrode segments 7152, 7154. In this implementation, voltage is not being supplied to either of the electrode segments 7152, 7154 and thus, the reflective member 7112 is in a quiescent, or stable, state. With the reflective member 7112 in a quiescent state, neither phase nor amplitude of the reflected light is modulated and the reflective member 7112 reflects the light to the pinhole-lenslet array with the same amplitude and phase as received from the light source.

FIG. 7B illustrates the symmetrical displacement of the reflective member 7112. When voltage is equally applied to both electrode segments 7152, 7154, the electrostatic forces create a uniform potential difference between the electrode segments 7152, 7154 and the reflective member 7112. As the reflective member 7112 experiences the electrostatic force of the electrode segments 7152, 7154, the torsional hinges 7162 allow the reflective member 7112 to uniformly displace in the direction of the electrode segments 7152, 7154. When the reflective member 7112 is positioned in this uniformly displaced state, the light directed to the reflective member 7112 takes longer to reach the plane of the reflective member 7112 as compared to when the reflective member 7112 is in the quiescent state. The time differential of light traveling to a displaced reflective member 7112 compared to light traveling to a quiescent reflective member creates the phase modulation of the reflected light. The electrostatic force supplied by the electrode segments 7152, 7154 can be manipulated in order to vary the degree of displacement of the reflective member 7112, and thus vary the degree of phase modulation between 0 and 2π radians.

FIG. 7C illustrates the asymmetrical displacement of the reflective member 7112. When voltage is supplied to only one electrode segment 7152, or to one electrode segment 7152 to a greater degree than to the other electrode segment 7154, a non-uniform potential difference is created between the reflective member 7112 and the electrode segments 7152, 7154. As the reflective member 7112 experiences the electrostatic force of the electrode segments 7152, 7154 in an asymmetrical manner, the torsional hinges 7162 allow the reflective member 7112 to be tilted towards the electrode segment 7152 which is providing the greater electrostatic force (i.e., receiving the larger voltage). When the reflective member 7112 is positioned in this tilted state, the light directed to the reflective member 7112 reflects at an angle incident to the direction in which it was received. As the reflected light travels to the pinhole-lenslet array (not shown), the amplitude can be modulated by blocking a portion of the reflected light with the pinhole edge. Thus, the total light output is modulated (in this case, reduced) in amplitude by blocking a portion of the exiting light. The electrostatic force supplied by the electrode segment 7152 can be manipulated in order to vary the tilting degree of the reflective member 7112, and thus vary the degree of amplitude modulation. In some implementations, the reflective member 7112 may be tilted to such a degree that all the reflected light is blocked by the pinhole edge and a black pixel is produced.

Because the reflective member 7112 can be axially displaced in addition to being tilted toward the more electrostatic electrode segment 7152, the light reflected by the reflective member 7112 also can be phase modulated. In another implementation, a Giles-Tornois phase resonator can be employed in each pixel of the holographic display in order to minimize the reflective member displacement and therefore, reduce energy requirements in the display. With a Giles-Tornois phase resonator, the desired phase modulation can still be achieved despite the reduced energy requirements. In this unillustrated implementation, a partially reflective member (not shown) can be placed in front of the reflective member 7112. Due to multiple-beam interference, an equivalent phase modulation can be achieved while displacing the reflective member 7112 only a fraction of the distance normally required without the additional partially reflective member.

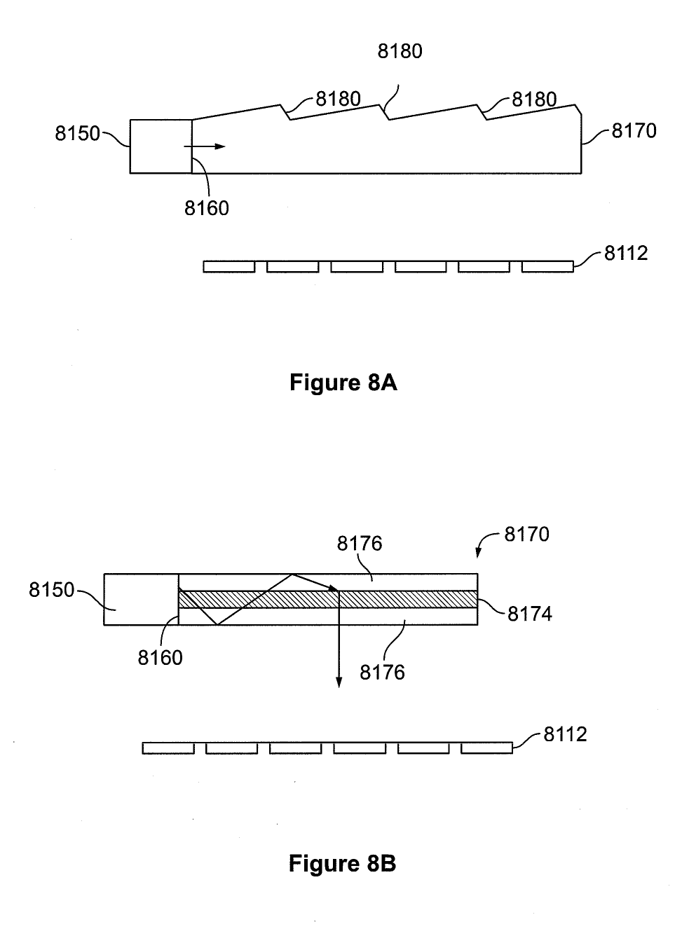

FIGS. 8A and 8B are example schematics illustrating an implementation of light guides. FIG. 8A illustrates an example implementation of a light guide 8170 that can be used to illuminate, e.g., the holographic display device 110. The holographic display device 110 can include a light source 8150 and a light guide 8170 which can, include, for example, one or more film, film stack, sheet, or slab-like components. The light guide 8170 can include turning elements 8180 that direct light propagating in the light guide to the reflective members 8112. The light turning elements 8180 can operate like small light sources each illuminating different pixels in the holographic display device 110. In some implementations, each of the light turning elements 8180 can correspond to one of the reflective members 8112. In some other implementations, a single light turning element 8180 can correspond to multiple reflective members 8112. The light source 8150 can be coupled to an edge 8160 of the light guide 8170 (i.e., “edge-coupled”) to provide light to the reflective members 8112. A portion of light emitted by the light source 8150 can enter the edge 8160 of the light guide 8170 and propagate throughout the light guide 8170 utilizing total internal reflection. The light guide 8170 can be implemented as a substantially planar structure. Although the light guide 8170 is described herein as substantially “planar,” one having ordinary skill in the art will readily appreciate that the light guide 8170, or portions thereof, may have additional surface features for reflecting, diffracting, refracting, or scattering light, or providing light emitting materials, and might not be smooth.

FIG. 8B illustrates another example implementation of a light guide 8170 that can be used to direct light to the reflective members 8112. In some implementations, the light guide 8170 can be based on a volume hologram. With a volume hologram, a holographic recording material 8174 is optionally sandwiched between two substrates 8176. In some implementations of a volume hologram, one of the substrates 8176 may not be present during recording, but instead included after the holographic recording is made. The holographic recording material 8174 can be a gel, a solid film, a light sensitive photopolymer resin, or other recording media. In some implementations, the holographic recording material 8174 has adhesive properties, or it is a film including an adhesive, such that the recording material 8174 can be placed on one side of a substrate 8176 and a light guide 8170 film can be applied to cover the recording material 8174, creating a film stack. In some implementations of a volume hologram, one or more recording beams (not displayed) can be coupled via a prism index matched to the holographic material 8174 (so that light enters from air at normal incidence onto the prism surface), and the back of the film can be index matched to a bulk material so as to prevent reflections from the back surface. Back surface reflections can create an unwanted set of holographic fringes in the reverse direction.

The light guide 8170 can use volume diffraction grating to redirect light propagating through the light guide 8170 towards the reflective members 8112. In some implementations, the volume diffraction grating is the only light directing feature used in the holographic display device 110. In other implementations, the volume diffraction grating can be combined with other light directing features (e.g., prismatic features, reflectors, surface diffraction features) to direct light more efficiently to a display.

In some implementations, the light source 8150 need not be edge-coupled to the light guide 8170. For example, the light source 8150 may be placed above or below the light guide 8170 and may be attached to a light coupling section of the light guide 8170. The light coupling section can be implemented to direct the light from the light source 8150 into a light turning portion of the light guide 8170. U.S. patent application Ser. No. 12/416,886, filed Apr. 1, 2009, provides additional implementations of light guides and light turning elements that are applicable for use in the holographic display device and methods described herein.

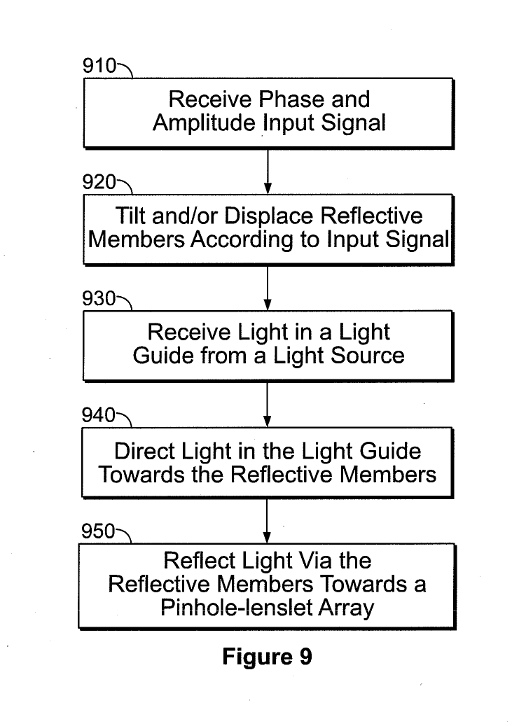

FIG. 9 is an example system flow diagram illustrating a method of displaying a holographic display. An initial step in the method, block 910, involves receiving an image data input signal in the display device. The image data input signal includes the required phase and amplitude of light information for each pixel in the array of pixels in order to effectuate the display of the hologram. The next step, block 920, involves tilting and/or displacing the reflective members according to the image data input signal. In some implementations, the image data input signal for a given pixel may dictate that the reflective member remain in its quiescent state, and therefore is not tilted or displaced at all. When the reflective member remains in the quiescent state, phase and amplitude of light are not modulated. Next, block 930, includes receiving light in the light guide from the light source. The light source may be implemented to provide continuous wave or pulsed light. Block 940 involves directing the light propagating in the light guide towards the reflective members. Finally, in block 950, the reflective members reflect the light with optionally modulated phase and/or amplitude towards a pinhole-lenslet array. As the light exits the pinholes, the combination of light from the plurality of pixels in the display device produces a holographic image for the viewer.

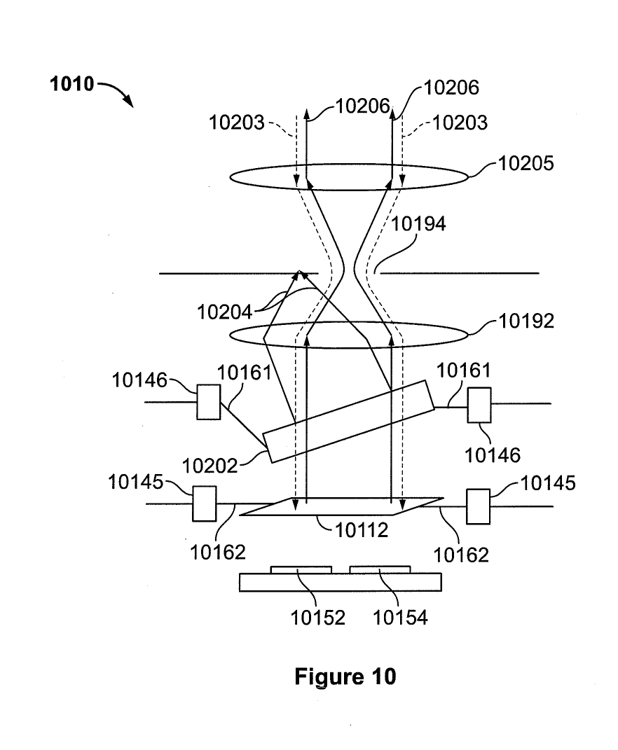

FIG. 10 is an example schematic illustrating one implementation of a single pixel of a holographic display utilizing a Fabry-Pérot element. White light, with a measure of spatial coherence, may be directed to a pixel 1010 by restricting the source aperture, such as by creating a point source of white light. The light 10203 is directed from a light source (not shown) towards the lenslet 10205; the incoming light can be focused by the lenslet 10205 towards the pinhole 10194. The light can pass through the pinhole 10194 and can reach a lenslet 10192.

In this implementation, a Fabry-Pérot element 10202 is positioned between a reflective member 10112 and the lenslet 10192. The Fabry-Pérot element 10202 includes two parallel mirrors and is configured to selectively pass, with high efficiency, only one color to the reflective member 10112. The selected color can be a function of the relative displacement of two parallel mirrors (not shown) in the Fabry-Pérot element.

Light waves not passed through the Fabry-Pérot element 10202 can be reflected by the Fabry-Pérot element 10202 as a reflection component 10204. The reflection component 10204 can be removed from the optical axis by tilting the Fabry-Pérot element 10202 sufficiently to reflect it back through the lenslet 10192 to be focused by the lenslet 10192 to a point on the pinhole 10194 edge. In this manner, the reflection component 10204 does not pass through the pinhole 10194 and is not visible to a viewer of the holographic display device.

As described above, the reflective member 10112 may be tilted or axially displaced in order to modulate the phase and amplitude of the light reflected by it. Two sides of the reflective member 10112 can be attached to immovable anchors 10145 by torsional hinges 10162; the hinges 10162 can be configured to allow the reflective member 10112 to tilt and/or axially shift, or displace, when a potential difference is created between the reflective member 10112 and the electrode segments 10152, 10154. In the illustrated implementation, the reflective member 10112 is in a quiescent state (being neither displaced nor tilted), and thus the light emanating from the pixel 1010 is not modulated.

In one implementation, the Fabry-Pérot element 10202 can be attached to immovable anchors 10146 on two sides by fixed supports 10161. The supports 10161 are configured to keep the Fabry-Pérot element 10202 spatially fixed at an angle such that the light reflected by Fabry-Pérot element 10202 is continuously blocked by the pinhole 10194 edge. The Fabry-Pérot element 10202 can be tuned by changing the gap spacing between the two parallel mirrors, or by slightly rotating the pair of mirrors.

The reflective member 10112 can reflect the light received from the Fabry-Pérot element 10202 back through the Fabry-Pérot element 10202 to the lenslet 10192. The lenslet 10192 can focus the light to a point of convergence at the plane of the pinhole 10194. The light can exit the pinhole 10194 and pass through the lenslet 10205, wherein the light 10206 can be perceived by, e.g., a viewer, as part of a holographic display.

In some implementations, each pixel 1010 in the pixel array can display only a single color at a time, according to how the Fabry-Pérot element 10202 is variably tuned. Following the display of one color, the Fabry-Pérot element 10202 may be rapidly tuned, i.e., by changing the relative displacement of the mirrors, to pass a different color to the reflective member 10112. In this manner, the combination of a plurality of variably tuned pixels in an array produces a full-color hologram emanating from the holographic display 110.

In some other implementations, a single pixel 1010 may include a Fabry-Pérot element 10202 tuned to only pass a single color, such as red, green or blue, to the reflective member 10112. In some implementations, different colored pixels may be arranged in close proximity to one another, such that when pixels of different colors are illuminated next to or near each other, the light emanating from the different colored pixels combines or mixes upon exit from the pinholes to produce a different color or different shade of color visible to, e.g., the viewer. In this manner, the combination of RGB pixels in the holographic display produces a full-color hologram.

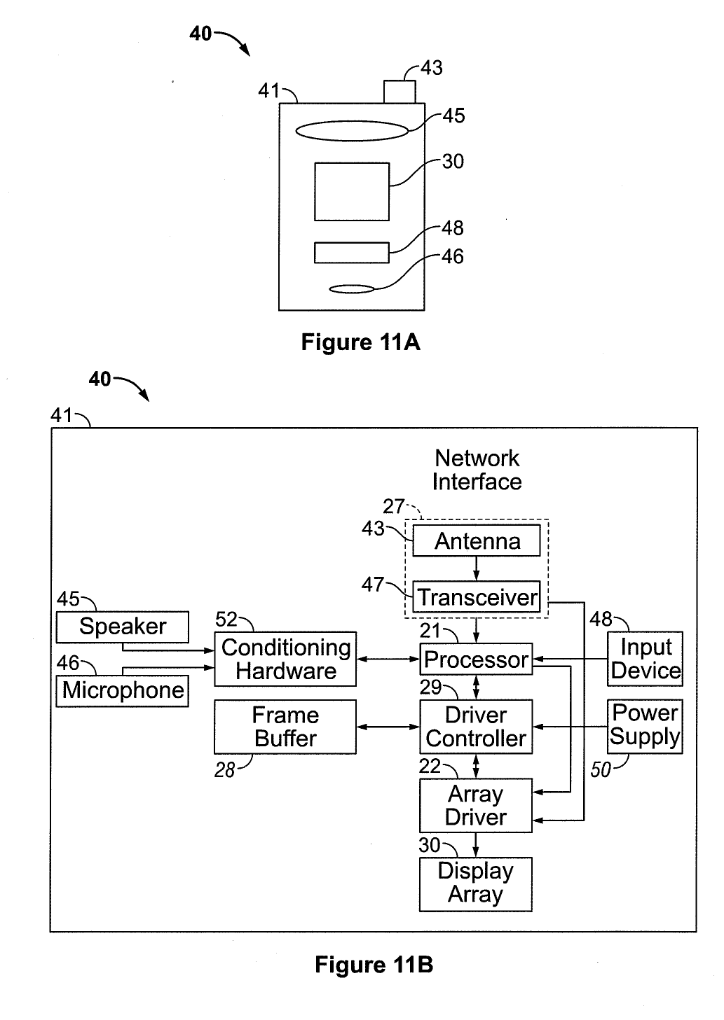

FIGS. 11A and 11B show examples of system block diagrams illustrating an implementation of a holographic display device including a plurality of interferometric modulators. FIGS. 11A and 11B show examples of system block diagrams illustrating an embodiment of a display device 40. The display device 40 can be, for example, a cellular or mobile telephone. However, the same components of display device 40 or slight variations thereof are also illustrative of various types of display devices such as televisions, e-readers and portable media players.

The display device 40 includes a housing 41, a display 30, an antenna 43, a speaker 45, an input device 48, and a microphone 46. The housing 41 can be formed from any of a variety of manufacturing processes, including injection molding, and vacuum forming. In addition, the housing 41 may be made from any of a variety of materials, including, but not limited to: plastic, metal, glass, rubber, and ceramic, or a combination thereof. The housing 41 can include removable portions (not shown) that may be interchanged with other removable portions of different color, or containing different logos, pictures, or symbols.

The display 30 may be any of a variety of displays, including a bi-stable or analog display, as described herein. The display 30 also can be configured to include a flat-panel display, such as plasma, EL, OLED, STN LCD, or TFT LCD, or a non-flat-panel display, such as a CRT or other tube device. In addition, the display 30 can include an interferometric modulator display, as described herein.

The components of the display device 40 are schematically illustrated in FIG. 11B. The display device 40 includes a housing 41 and can include additional components at least partially enclosed therein. For example, the display device 40 includes a network interface 27 that includes an antenna 43 which is coupled to a transceiver 47. The transceiver 47 is connected to a processor 21, which is connected to conditioning hardware 52. The conditioning hardware 52 may be configured to condition a signal (e.g., filter a signal). The conditioning hardware 52 is connected to a speaker 45 and a microphone 46. The processor 21 is also connected to an input device 48 and a driver controller 29. The driver controller 29 is coupled to a frame buffer 28, and to an array driver 22, which in turn is coupled to a display array 30. A power supply 50 can provide power to all components as required by the particular display device 40 design.

The network interface 27 includes the antenna 43 and the transceiver 47 so that the display device 40 can communicate with one or more devices over a network. The network interface 27 also may have some processing capabilities to relieve, e.g., data processing requirements of the processor 21. The antenna 43 can transmit and receive signals. In some implementations, the antenna 43 transmits and receives RF signals according to the IEEE 16.11 standard, including IEEE 16.11(a), (b), or (g), or the IEEE 802.11 standard, including IEEE 802.11a, b, g or n. In some other implementations, the antenna 43 transmits and receives RF signals according to the BLUETOOTH standard. In the case of a cellular telephone, the antenna 43 is designed to receive code division multiple access (CDMA), frequency division multiple access (FDMA), time division multiple access (TDMA), Global System for Mobile communications (GSM), GSM/General Packet Radio Service (GPRS), Enhanced Data GSM Environment (EDGE), Terrestrial Trunked Radio (TETRA), Wideband-CDMA (W-CDMA), Evolution Data Optimized (EV-DO), 1xEV-DO, EV-DO Rev A, EV-DO Rev B, High Speed Packet Access (HSPA), High Speed Downlink Packet Access (HSDPA), High Speed Uplink Packet Access (HSUPA), Evolved High Speed Packet Access (HSPA+), Long Term Evolution (LTE), AMPS, or other known signals that are used to communicate within a wireless network, such as a system utilizing 3G or 4G technology. The transceiver 47 can pre-process the signals received from the antenna 43 so that they may be received by and further manipulated by the processor 21. The transceiver 47 also can process signals received from the processor 21 so that they may be transmitted from the display device 40 via the antenna 43.

In some implementations, the transceiver 47 can be replaced by a receiver. In addition, the network interface 27 can be replaced by an image source, which can store or generate image data to be sent to the processor 21. The processor 21 can control the overall operation of the display device 40. The processor 21 receives data, such as compressed image data from the network interface 27 or an image source, and processes the data into raw image data or into a format that is readily processed into raw image data. The processor 21 can send the processed data to the driver controller 29 or to the frame buffer 28 for storage. Raw data typically refers to the information that identifies the image characteristics at each location within an image. For example, such image characteristics can include color, saturation, and gray-scale level.

The processor 21 can include a microcontroller, CPU, or logic unit to control operation of the display device 40. The conditioning hardware 52 may include amplifiers and filters for transmitting signals to the speaker 45, and for receiving signals from the microphone 46. The conditioning hardware 52 may be discrete components within the display device 40, or may be incorporated within the processor 21 or other components.

The driver controller 29 can take the raw image data generated by the processor 21 either directly from the processor 21 or from the frame buffer 28 and can re-format the raw image data appropriately for high speed transmission to the array driver 22. In some implementations, the driver controller 29 can re-format the raw image data into a data flow having a raster-like format, such that it has a time order suitable for scanning across the display array 30. Then the driver controller 29 sends the formatted information to the array driver 22. Although a driver controller 29, such as an LCD controller, is often associated with the system processor 21 as a stand-alone Integrated Circuit (IC), such controllers may be implemented in many ways. For example, controllers may be embedded in the processor 21 as hardware, embedded in the processor 21 as software, or fully integrated in hardware with the array driver 22.

The array driver 22 can receive the formatted information from the driver controller 29 and can re-format the video data into a parallel set of waveforms that are applied many times per second to the hundreds, and sometimes thousands (or more), of leads coming from the display's x-y matrix of pixels.

In some implementations, the driver controller 29, the array driver 22, and the display array 30 are appropriate for any of the types of displays described herein. For example, the driver controller 29 can be a conventional display controller or a bi-stable display controller (e.g., an IMOD controller). Additionally, the array driver 22 can be a conventional driver or a bi-stable display driver (e.g., an IMOD display driver). Moreover, the display array 30 can be a conventional display array or a bi-stable display array (e.g., a display including an array of IMODs). In some implementations, the driver controller 29 can be integrated with the array driver 22. Such an implementation is common in highly integrated systems such as cellular phones, watches and other small-area displays.

In some implementations, the input device 48 can be configured to allow, e.g., a user to control the operation of the display device 40. The input device 48 can include a keypad, such as a QWERTY keyboard or a telephone keypad, a button, a switch, a rocker, a touch-sensitive screen, or a pressure- or heat-sensitive membrane. The microphone 46 can be configured as an input device for the display device 40. In some implementations, voice commands through the microphone 46 can be used for controlling operations of the display device 40.

The power supply 50 can include a variety of energy storage devices as are well known in the art. For example, the power supply 50 can be a rechargeable battery, such as a nickel-cadmium battery or a lithium-ion battery. The power supply 50 also can be a renewable energy source, a capacitor, or a solar cell, including a plastic solar cell or solar-cell paint. The power supply 50 also can be configured to receive power from a wall outlet.

In some implementations, control programmability resides in the driver controller 29 which can be located in several places in the electronic display system. In some other implementations, control programmability resides in the array driver 22. The above-described optimization may be implemented in any number of hardware and/or software components and in various configurations.

The various illustrative logics, logical blocks, modules, circuits and algorithm steps described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and steps described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, or, any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration. In some implementations, particular steps and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also can be implemented as one or more computer programs, i.e., one or more modules of computer program instructions, encoded on a computer storage media for execution by, or to control the operation of, data processing apparatus.

Various modifications to the implementations described in this disclosure may be readily apparent to those skilled in the art, and the generic principles defined herein may be applied to other implementations without departing from the spirit or scope of this disclosure. Thus, the disclosure is not intended to be limited to the implementations shown herein, but is to be accorded the widest scope consistent with the claims, the principles and the novel features disclosed herein. The word “exemplary” is used exclusively herein to mean “serving as an example, instance, or illustration.” Any implementation described herein as “exemplary” is not necessarily to be construed as preferred or advantageous over other implementations. Additionally, a person having ordinary skill in the art will readily appreciate, the terms “upper” and “lower” are sometimes used for ease of describing the figures, and indicate relative positions corresponding to the orientation of the figure on a properly oriented page, and may not reflect the proper orientation of the IMOD as implemented.

Certain features that are described in this specification in the context of separate implementations also can be implemented in combination in a single implementation. Conversely, various features that are described in the context of a single implementation also can be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single software product or packaged into multiple software products. Additionally, other implementations are within the scope of the following claims. In some cases, the actions recited in the claims can be performed in a different order and still achieve desirable results.

What is claimed is:

1. A holographic display device, comprising:
a plurality of reflective members being configured to selectively adjust; and
a pinhole-lenslet array, including a plurality of pinholes and a plurality of lenslets;
wherein at least one of the phase and amplitude of light is selectively modulated, based, at least in part on, the positioning of the plurality of reflective members.

2. The display device of claim 1, further comprising a light source configured to supply light to the display device.

3. The display device of claim 2, further comprising a light guide configured to receive light from the light source and direct light to at least one of the plurality of reflective members.

4. The display device of claim 3, wherein the light guide is disposed between the reflective members and the pinhole-lenslet array.

5. The display device of claim 3, wherein the light guide is disposed between the plurality of lenses and the plurality of pinholes of the pinhole-lenslet array.

6. The display device of claim 2, wherein the light source includes one or more lasers.

7. The display device of claim 1, wherein the plurality of reflective members are configured to selectively tilt and displace.

8. The display device of claim 1, further comprising a Fabry-Pérot element disposed between the reflective members and the pinhole-lenslet array.

9. The display device of claim 1, further comprising a plurality of electrode segments located proximately behind the plurality of reflective members, the plurality of electrode segments being configured to selectively displace and tilt at least one of the reflective members.

10. The display device of claim 9, wherein the plurality of electrode segments selectively displace or tilt the reflective members based upon an image data input signal.

11. The display device of claim 10, further comprising:
a processor that is configured to communicate with the plurality of electrode segments, the processor being configured to process image data; and
a memory device that is configured to communicate with the processor.

12. The display device of claim 11, further comprising a driver circuit configured to send at least one signal to the electrode segments.

13. The display device of claim 12, further comprising a controller configured to send at least a section of the image data to the driver circuit.

14. The display device of claim 11, further comprising an image source module configured to send image data to the processor.

15. A method for displaying a holographic image, comprising:
receiving a plurality of phase and amplitude input signals;
tilting and displacing a plurality of reflective members according to the input signals;
directing light towards the plurality of reflective members; and
reflecting the light via the plurality of reflective members towards a pinhole-lenslet array, comprised of a plurality of pinholes and a plurality of lenslets, wherein the light is focused by the lenslets towards the pinholes.

16. The method of claim 16, wherein the phase of light is modulated by axially displacing at least one of the plurality of reflective members.

17. The method of claim 16, wherein the amplitude of light is modulated by tilting at least one of the reflective members and reflecting light through the pinhole-lenslet array.

18. The method of claim 16, further comprising receiving light in a light guide from a light source, wherein at least a portion of the received light is directed towards one or more of the plurality of reflective members.

19. The method of claim 18, wherein the light guide is disposed between the reflective members and the pinhole-lenslet array.

20. The method of claim 18, wherein the light guide is disposed between the plurality of lenses and the plurality of pinholes of the pinhole-lenslet array.

21. The method of claim 18, wherein the light source generates a pulsed light, comprised of red, green and blue light, wherein each color of light can be pulsed sequentially in time.

22. The method of claim 18, wherein the light source generates a constant light, comprised of red, green and blue light, wherein each color of light is directed by the light guide to a corresponding reflective member of the plurality of reflective members.

23. The method of claim 18, wherein the light source generates a time-modulated light, comprising red, green and blue light.

24. The method of claim 16, further comprising passing white light through a plurality of Fabry-Pérot elements disposed between the reflective members and the pinhole-lenslet array, wherein the light of only one color is directed towards the reflective members.

25. A holographic display device, comprising:
means for reflecting light, the light reflecting means being configured to selectively adjust;
means for focusing light; and
means for selectively blocking light, wherein the light focusing means and light blocking means modulate at least one of the phase and amplitude of the light reflected to at least one of the light focusing means or the light blocking means based at least in part on the positioning of the light reflecting means.

26. The display device of claim 25, further comprising means for emitting light.

27. The display device of claim 26, further comprising means for guiding light, the light guiding means being configured to receive light from the light emitting means and direct light to the light reflecting means.

28. The display device of claim 27, wherein the light guiding means is disposed between the reflecting means and the light focusing means.

29. The display device of claim 27, wherein the light guiding means is disposed between the light reflecting means and the light blocking means.

30. The display device of claim 25, wherein the light blocking means includes a pinhole.

31. The display device of claim 25, further comprising means for selectively passing light of a single color to the light reflecting means.

32. The display device of claim 26, wherein the light emitting means includes one or more lasers.
